(19) United States
(12) Patent Application Publication
(10) Pub. No.: US 2018/0338502 A1
(43) Pub. Date: Nov. 29, 2018

(54) Natural mosquito repellent laundry products

(71) Applicants: KASEE JASTIN HAYES, EDMOND, OK (US); MIRANDA ANNE ALMEN, EDMOND, OK (US); CAROLINA LEE COLLINS, EDMOND, OK (US)

(72) Inventors: KASEE JASTIN HAYES, EDMOND, OK (US); MIRANDA ANNE ALMEN, EDMOND, OK (US); CAROLINA LEE COLLINS, EDMOND, OK (US)

(21) Appl. No.: 15/731,315

(22) Filed: May 24, 2017

(51) Int. Cl. A01N 65/40; A01N 25/34; A01N 65/22; A01N 65/28; C11D 17/04; C11D 3/00; C11D 3/20

(52) U.S. Cl. CPC A01N 65/40; A01N 25/34; A01N 65/22; C11D 3/2079; C11D 17/047; C11D 3/001; A01N 65/28

(57) ABSTRACT

An infused dryer sheet and fabric detergent containing one or more essential oil derivatives to infuse clothing with a safe insect repellent, directed especially towards disease carrying mosquitoes, the dryer sheets and detergent containing an essential oil mixture safe for clothing worn by pregnant women and other human beings and pets.

### CROSS REFERENCE TO RELATED APPLICATIONS

None.

### I. BACKGROUND OF THE INVENTION

### 1. Field of Invention

An infused dryer sheet and fabric detergent containing one or more essential oil derivatives to infuse clothing with a safe insect repellent, directed especially towards disease carrying mosquitoes, the dryer sheets and detergent containing an essential oil mixture safe for clothing worn by pregnant women and other human beings and pets.

### 2. Description of Prior Art

A preliminary review of prior art patents was conducted by the applicant which reveal prior art patents in a similar field or having similar use. However, the prior art inventions do not disclose the same or similar elements as the present insect repellent infused dryer sheets, nor do they present the material components in a manner contemplated or anticipated in the prior art.

In Patent No. WO2013/050967 to Manhas, a peppermint oil based insecticide is disclosed which contains a polar aromatic solvent. It does not appear to be intended for use in clothing that has contact with the skin or for use in the laundry. What appears to be a toxic insecticide containing pyrethrin is used for coating textile or plastics at the time impregnated into the fabrics at textile finishing plants in U.S. Patent Application No. 2005/0132500 to Karl. It also contains essential oil derivatives. This does not appear to be suitable for clothing and those skilled in the art would not allow their wives to wear clothing containing pyrethrin while they were pregnant, nor expose their young children to these garment, basically based upon the chemical labeling on products containing this substance.

In U.S. Patent Application No. 2004/0197364 to Brown, peppermint is included in another product that also includes eucalyptus oil, catnip oil, DMSO or MSM, aloe vera, jojoba oil, and tea tree oil. It claims to be useful in topical application. Once agian, there is no mention of inclusion in laundry or dryer, no mention of infusion into clothing, and no mention of safety regarding use for pregnant women or small children, the DMSO being another dangerous solvent, even though included at only 2-6% by weight. DMSO is a known surfactant and is capable of transfer through the skin. It is doubtful that this product would be advisable for pregnant women or small children and it has no indicated use in the laundry. Likewise, U.S. Patent Application No. 2003/0026823 is an insect repellent containing two or more preferred essential oils including geranium oil, rosemary oil and peppermint oil, but also including synergists including aldehyde C-14 and aldehyde C-18. Vanilla is used as a desired ingredient as a stabilizer, fragrance, fragrance enhancer and surfactant. Citronella oil, and lemon oil are also included as required ingredients and this application prescribes no use in the laundry. It states it in environmentally safe, but does not address issues of safety for topical contact with the target pregnant women and small children intended in the present invention. The same basic ingredients are used in U.S. Patent Application No. 2002/0034556 to Khazan, with the only apparent distinction being lavender oil and piperitone, claiming to be safe for humans, and also details impregnation into candles, tablecloths, inks, textiles and personal care products but not through laundry detergents, detergent additives or dryer sheets.

An environmental insecticide is disclosed in U.S. Pat. No. 5,633,236 to Warren that exposes a 3 dimension space to an effective repellent concentration of a mixture of geraniol plus a portion of citronellol and nerol and contained in a polymer. Again, no mention of a detergent or fabric infusion is mentioned anywhere in the patent. A finial disclosed patent, U.S. Pat. No. 5,196,200 to Wilson, mentions an isomeric mixture used in fabric softeners by a method involving dehydrating nerolidol using citric acid or phosphoric acid and distilling the resulting product at particular temperature and pressure ranges to prepare a composition of matter useful for augmenting or enhancing natural, dry, floral, opoponax aromas with fragrances and the like to repel mosquitoes. Applicant has no knowledge if this has any bearing on the present product and in good faith indeed doubts that it would serve as prior art for the preset product, but has included it in this disclosure because it appears to repel mosquitoes which specifically identify the type that carry Zika, and included the words “fabric softener compositions”. The present composition and delivery medium involved in the present invention are intended to repel two types of Zika carrying mosquitoes—Aedes aegypti—identified in the Wilson patent—and Aedes albopictus—not identified in Wilson, but known in the art to be those mosquito species that have gained prominence in the southern United States.

### II. SUMMARY OF THE INVENTION

Serious diseases are passed from mosquitoes to people all over the world, including malaria, ZIKA, West Nile virus, Dengue Fever, Chikungunya and dog heartworm disease. Cures are costly, sometimes ineffective and often applied too late to prevent damage from the disease. The prior art has indicated several different techniques and methods of preventing mosquito bites, including a great number of chemicals, oils and other ingredients to dispel the mosquitos from biting and preferable from even landing on a person or pet.

The problem identified addressed by the present composition is preventing the spread of disease by known mosquito species—primarily the Aedes albopictus and the Aedes aegypti mosquitoes, identified by the CDC as the carrier of the Zika virus and other blood borne diseases. The Zika virus was first report by Brazilian authorities in May of 2015, seen in the United States as early as February of 2016, and has since spread to the Untied States and 26 other countries since its initial reporting. The United States CDC reports as many as 5,158 Zika virus cases with 222 of those involving local transmission. The U.S. Territories have reported over 38,000 cases, with nearly all of them being local transmission. https://www.ede.gov/zika/geo/united-states.html.

Common ingredients in topically applied sprays and lotions include the use of DEET, or N,N-Diethyl-met-toluamide. DEET has been used for topical application, but safety concerns have risen, with prolonged exposure to DEET leading to brain cell death due to some transmission of the DEET through the skin. See, http://www.scientificamerican.com/article/is-it-true-that-the-deet/. It is also warned that children under 2 months should not use products containing DEET, according to the America Academy of Pediatrics and the FDA. See, http:/npic.orst.edu/factsheets/DEETgen.html#body. Prior art has also disclosed use of fabric with factory infused insecticides and topical skin rubs and sprays which contain certain oil product derived from natural sources, most with ingredients which pose a risk to human health, especially pregnant women and small children.

The purpose of the present composition is to deliver the oil mixture products into clothing for people of all ages and health conditions which does not pose a risk to the person wearing the clothing or cause irritations to the skin. It is also the intent of the present mixture to deliver the product for long lasting use. In the fabric sheets, it is the intent to deliver the product in a heat activated release during the drying process to be infused into the clothing. In the detergent, it is the intent to deliver the product in a wet matrix during the washing process or at the end of the wash cycle as a rinse to infuse the clothing while wet for later drying, with the repellent mixture products maintained in the clothing subsequent to the rinse cycle.

### III. DESCRIPTION OF THE DRAWINGS

There are no drawings submitted in this application.

### IV. DESCRIPTION OF THE PREFERRED EMBODIMENT

An insect repellent mixture using natural product oil derivatives is provided in laundry products, including dryer sheets and detergents, to be infused within clothing to repel disease carrying insects, primarily mosquitos, for all persons including pregnant women and small children, who are high risk for those viruses and other diseases and blood borne pathogens. The insect repellent mixture provides one or more natural oils within the mixture known and proven by testing to repel mosquitoes and also other ingredients suitable for use in dryer sheets, detergents and other laundry products.

Fabric sheets are provided commencing with a chosen delivery matrix, usually a dimensional sheet, with the insect repellent mixture infused into the matrix. The matrix may be any fabric, textile or thin sheet material that can withstand the heat of a dryer and the tumbling action of the clothing within the dryer during at least one drying cycle without deformation, damage or decay and also the ability to absorb the mixture and present the mixture is dry or moist sheets. A suitable matrix for purposes of the product possessing the appropriate characteristics described above was found to be a non-woven, non-fusible interfacing used in quilting, or other thin sheet materials already used in the dryer sheet industry. The matrix is not necessarily part of the patentable subject matter of the invention if indeed using a product already in use in the field of art for use during the drying phase. In the detergent product, the detergent may be any product used in the laundry industry, again, the detergent not being the subject matter of the immediate invention, but the matrix for delivery of the inventive subject matter to clothing during the wash phase.

The first ingredient is the insect repellent mixture is the insect repelling essential oil, chosen from a list including citronella, lemongrass, lemon eucalyptus, lavender, clove, basil, peppermint, rosemary and common eucalyptus. The preferred essential oils would be introduced as colorless extract oils ranging from a 1.5% solution to a 7% solution by weight, depending on the subject essential oil derivative. During testing, the most effective concentration of oil was determined for each essential oil, the gained data interpreted using the World Health Organization formula for determination of the effective spatial repellency of oils, as follows:

$$\frac{G - R}{G + R} ∘ \frac{G + R}{All}$$

The mathematic result is rendered as a Spatial Activity Index value or SAI. The trials used samples of the essential oil derivatives at variable concentrations for 1 minute and 5 minute trials using live female mosquitoes of the variety Aedes aegypti mosquitos in a cage, with volunteers holding swatches pre-washed in the subject detergent formula mixtures, individually and combined. The SAI effectiveness is grades by a higher index number determined in direct proportion to the mosquito repellent quality of the subject sample. The following data was obtained.

| Oil | 1.5% @ SAI | 3.0% @ SAI | 7% @ SAI |
|---|---|---|---|
| citronella | 0.473 | 0.667 | 0.687 |
| lemon eucalyptus | 0.580 | 0.680 | 0.347 |
| clove | 0.667 | 0.493 | 0.553 |
| basil | 0.627 | 0.587 | 0.400 |
| peppermint | 0.827 | 0.720 | 0.720 |
| lemongrass | 0.513 | 0.587 | 0.520 |
| rosemary | 0.733 | 0.620 | 0.700 |
| common eucalyptus | 0.567 | 0.707 | 0.353 |
| lavender | 0.407 | 0.520 | 0.607 |
| peppermint (3%) + | N/A | 0.387 | N/A |
| eucalypts (3%) | | | |
| rosemary (3%) + | N/A | 0.293 | N/A |
| eucalyptus (3%) | | | |
| lemongrass (3%) + | N/A | 0.493 | N/A |
| eucalyptus (3%) | | | |

From the results gained above, a determination was made that the combination of oils proved to lessen the repellent quality of the essential oils, and that the effectiveness of the repellent essential oils by concentration were dependent on the particular essential oil. Therefore, the conclusion was that peppermint and rosemary, at 1.5% concentration by weight were most effective, but that the eucalyptus (3%), basil (1.5%), clove (1.5%), lemongrass (3%), lemon eucalyptus (3%), lavender (7%) and citronella (7%), proved to have effective repellent traits, effective being defined by the test protocol as above 0.50 SAI. The combination of oils tended to reduce the repellent qualities of the essential oils. Further testing would be required to determine and discover more synergistic effects between most of the effective oils.

It is also determined in the dryer sheet embodiment that the addition of vanillin or other prolonging agent, prolongs the effectiveness of the essential oil and enhances the release of the essential oil throughout the drying cycle, infusing the essential oils into the clothing more efficiently. The addition of natural vinegar or other natural fabric softener enhances the fabric softening quality of the dryer sheet. Therefore, the most efficient mixture for infusion into a dryer sheet would include:

at least one essential oil concentration having an SAI index above 0.500+a quantity of vanillin (vanilla oil extract)+a small quantity of low fragrant vinegar+witch hazel extract=infusing mixture

As indicated above, the variable in the mixture's basic formula would be the type of essential oil and its relative concentration.

As with the detergent additive, witch hazel is introduced with an essential oil to reduce the chance of skin irritation caused by the essential oil, since the detergent is saturated directly into the clothing during the wash cycle and can vary as to how much of the mixture is actually contained within the clothing, as well as how the clothing is finished (line drying versus machine drying; drying cycle selection with variable heat, time and tumble intensity). The vanillin and vinegar recommended in the dryer sheet formula is not used in the detergent embodiment. Thus, the most efficient mixture for inclusion in a detergent would include:

at least one essential oil concentration having an SAI index above 0.500+a quantity of witch hazel extract+a detergent laundry soap=inclusion mixture

Once again, the variable in the mixture's basic detergent formula would be the type of essential oil and its relative concentration. Witch hazel, otherwise known as winterbloom, is a plant extract added to reduce the risk of skin irritation and provide other beneficial effects to the skin. Witch hazel can help reduce acne and other skin disorders, shrink blood vessels, promote fast wound healing, sooth itching, and refresh and rejuvenate the skin. It has gained notoriety in barber shops as an aftershave lotion, delivered as witch hazel water, mixed with water or alcohol.

While the natural mosquito repellent laundry products been particularly shown and described with reference to a preferred embodiment thereof, it will be understood by those skilled in the art that changes in form and detail may be made therein without departing from the spirit and scope of the invention.

What is claimed is:

1. An insect repellent mixture using natural product oil derivatives provided in laundry product infused within clothing during laundering, the insect repellent repelling disease carrying insect, primarily mosquitos, for all persons including pregnant women and small children who are high risk for viruses, other diseases and commonly carried blood borne pathogens, said insect repellent laundry product comprising:
a dryer sheet made of fabric, textile or thin sheet material that can withstand the heat of a dryer and the tumbling action of the clothing within the dryer during at least one drying cycle without deformation, damage or decay and also the ability to absorb the mixture and present the mixture is dry or moist sheets;
at least one essential oil selected from a list of essential oils including citronella, lemongrass, lemon eucalyptus, lavender, clove, basil, peppermint, rosemary and common eucalyptus in a concentration between 1.5% and 7% by weight;
vanillin to prolong the release of the essential oil throughout a drying cycle; and
low fragrance vinegar or other natural softening agent to soften the clothing during said drying cycle.

2. The insect repellent mixture of claim 1, wherein said at least one essential oil is a 1.5% concentration of peppermint oil by weight.

3. The insect repellent mixture of claim 1, wherein said at least one essential oil is a 1.5% concentration of rosemary oil by weight.

4. The insect repellent mixture of claim 1, wherein said at least one essential oil is a 3.0% concentration of eucalyptus oil by weight.

5. The insect repellent mixture of claim 1, wherein said at least one essential oil is a 1.5% concentration of basil oil by weight.

6. The insect repellent mixture of claim 1, wherein said at least one essential oil is a 1.5% concentration of clove oil by weight.

7. The insect repellent mixture of claim 1, wherein said at least one essential oil is a 3.0% concentration of lemongrass oil by weight.

8. The insect repellent mixture of claim 1, wherein said at least one essential oil is a 3.0% concentration of lemon eucalyptus oil by weight.

9. The insect repellent mixture of claim 1, wherein said at least one essential oil is a 7.0% concentration of lavender oil by weight.

10. The insect repellent mixture of claim 1, wherein said at least one essential oil is a 7.0% concentration of citronella oil by weight.

11. An insect repellent mixture using natural product oil derivatives provided in laundry product infused within clothing during laundering, the insect repellent repelling disease carrying insect, primarily mosquitos, for all persons including pregnant women and small children who are high risk for viruses, other diseases and commonly carried blood borne pathogens, said insect repellent laundry product comprising:
a detergent for washing clothing in a washing machine;
at least one essential oil selected from a list of essential oils including citronella, lemongrass, lemon eucalyptus, lavender, clove, basil, peppermint, rosemary and common eucalyptus in a concentration between 1.5% and 7% by weight; and
a quantity of witch hazel extract, also known as winterbloom.

12. The insect repellent mixture of claim 11, wherein said at least one essential oil is a 1.5% concentration of peppermint oil by weight.

13. The insect repellent mixture of claim 11, wherein said at least one essential oil is a 1.5% concentration of rosemary oil by weight.

14. The insect repellent mixture of claim 11, wherein said at least one essential oil is a 3.0% concentration of eucalyptus oil by weight.

15. The insect repellent mixture of claim 11, wherein said at least one essential oil is a 1.5% concentration of basil oil by weight.

16. The insect repellent mixture of claim 11, wherein said at least one essential oil is a 1.5% concentration of clove oil by weight.

17. The insect repellent mixture of claim 11, wherein said at least one essential oil is a 3.0% concentration of lemongrass oil by weight.

18. The insect repellent mixture of claim 11, wherein said at least one essential oil is a 3.0% concentration of lemon eucalyptus oil by weight.

19. The insect repellent mixture of claim 11, wherein said at least one essential oil is a 7.0% concentration of lavender oil by weight.

20. The insect repellent mixture of claim 11, wherein said at least one essential oil is a 7.0% concentration of citronella oil by weight.
